(19) United States
(12) Patent Application Publication
(10) Pub. No.: US 2009/0321456 A1
(43) Pub. Date: Dec. 31, 2009

(54) OBJECT STORAGE DEVICE

(76) Inventor: Liqiang Yang, Wehai City (CN)

Correspondence Address: QUARLES & BRADY LLP, 33 E. MAIN ST, SUITE 900, P.O BOX 2113, MADISON, WI, 53701-2113, US

(21) Appl. No.: 12/491,388

(22) Filed: Jun. 25, 2009

Related U.S. Application Data
(60) Provisional application No. 61/075,387, filed on Jun. 25, 2008.

(51) Int. Cl. B65D 25/02; B32B 3/30

(52) U.S. Cl. 220/600; 428/167

(57) ABSTRACT

An object storage device that includes a base and a deformable body having a bottom surface fixed to the base is provided. The body also includes body end surfaces, a longitudinal axis, a transverse axis extending between the body end surfaces, and a plurality of fingers. Each of the fingers includes an upper portion opposite the bottom surface, the upper portion including at least one planar diagonally extending surface configured to guide an object. Each of the fingers also includes finger side surfaces, and the finger side surfaces of adjacent fingers are frictionally engaged. With this construction, the object storage device may hold an object in place by friction forces due to contact between the sides of the object and the finger side surfaces. As such, the possibility of piercing the device with a sharp part of an object may be reduced.

### CROSS-REFERENCE TO RELATED APPLICATIONS

This application claims the benefit of U.S. Provisional Patent Application No. 61/075,387 filed Jun. 25, 2008, the disclosure of which is hereby incorporated by reference in entirety.

### STATEMENT REGARDING FEDERALLY SPONSORED RESEARCH OR DEVELOPMENT

Not applicable.

### FIELD OF THE INVENTION

The invention relates to a device for storing small objects.

### BACKGROUND OF THE INVENTION

Storage devices are well known in the art for storing and sometimes organizing sets of small objects, such as fishing lures, jewelry, sewing accessories, and other similar objects. Some storage devices simply provide a case with partitioned compartments in which objects are placed. Such devices are typically inexpensive but do not secure objects within the compartments. Therefore, objects can easily be spilled if the storage device is tipped.

Other types of storage devices provide a case with slits or grooves in which objects can be placed and secured. The slits or grooves may be provided in a foam component such that a hooked or pointed end of an object to be stored may pierce the foam. As such, the object is secured to the storage device. However, repeated piercing of the foam can significantly reduce its useable life, requiring the foam to be replaced or a new storage device to be obtained. In addition, the slits may be difficult to locate if they are provided on flat surfaces.

Considering the limitations of previous storage devices for small objects, an improved design is needed.

### SUMMARY OF THE INVENTION

The present invention provides an object storage device that includes a base and a deformable body having a bottom surface fixed to the base. The body also includes body end surfaces, a longitudinal axis, a transverse axis extending between the body end surfaces, and a plurality of fingers. Each of the fingers includes an upper portion opposite the bottom surface, the upper portion including at least one planar diagonally extending surface configured to guide an object. Each of the fingers also includes finger side surfaces, and the finger side surfaces of adjacent fingers are frictionally engaged.

In some embodiments of the invention, each upper portion has an inverted v-shape. In addition, the fingers may be positioned in generally the same orientation. In some embodiments of the invention, each finger has a generally constant cross-sectional shape as viewed in the direction of the transverse axis.

The foregoing and other objects and advantages of the invention will appear in the detailed description that follows. In the description, reference is made to the accompanying drawings that illustrate a preferred embodiment of the invention.

### BRIEF DESCRIPTION OF THE DRAWINGS

FIG. 1 is a perspective view of an object storage device according the present invention;

FIG. 2 is a side elevation view of the object storage device of FIG. 1;

FIG. 3 is a top plan view of the object storage device of FIG. 1;

FIG. 4 is a top view of a base supporting several object storage devices according to the present invention;

FIG. 5 is a partial perspective view of the base of FIG. 4;

FIG. 6 is a perspective view of a fly fishing lure being inserted into the object storage device of FIG. 1; and

FIG. 7 is a perspective view of a fly fishing lure being removed from the object storage device of FIG. 1.

### DETAILED DESCRIPTION OF THE PREFERRED EMBODIMENT

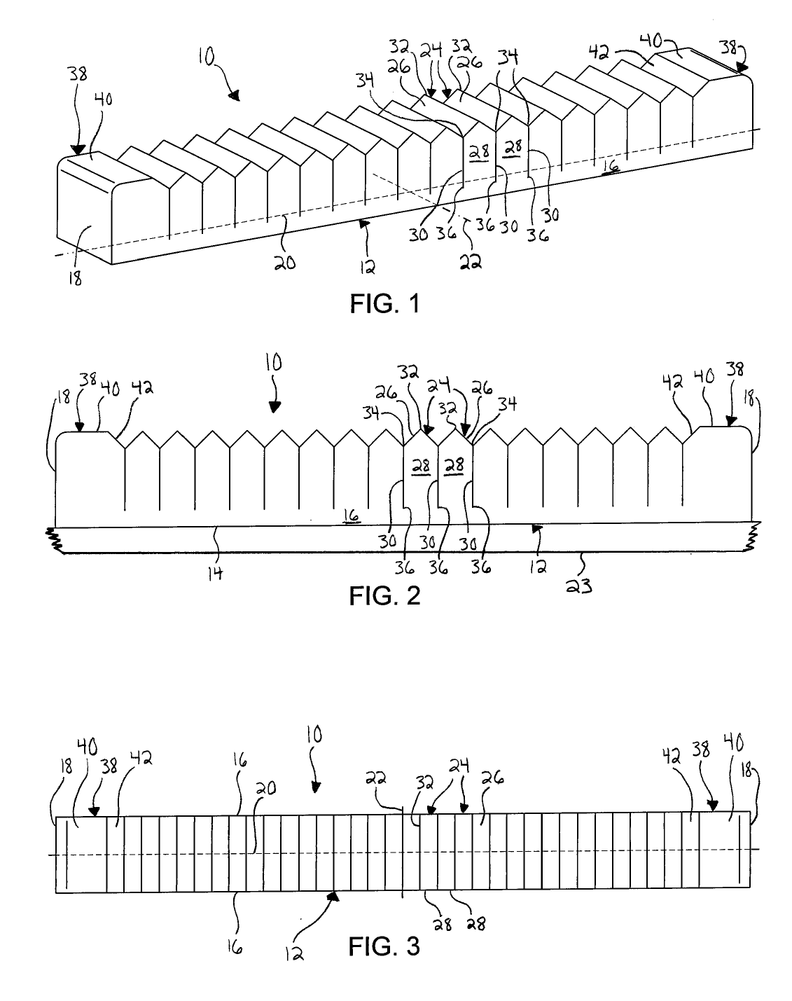

Referring to FIGS 1-3, an object storage device 10 of the present invention includes a body 12 made of deformable elastomeric foam. As the name implies, the elastomeric foam preferably deforms due to contact with another object and returns to its original shape when the other object is removed. Materials from which the body 12 may be made will be described in further detail below. The body 12 includes a bottom surface 14, two body end surfaces 16, and two body side surfaces 18. The bottom surface 14 defines a longitudinal axis 20 that extends through the body side surfaces 18. The bottom surface 14 also defines a transverse axis 22 that is generally perpendicular to the longitudinal axis 20. In addition, the bottom surface 14 may attach to a base 23 (FIG. 2) of a box in which a plurality of object storage devices are located. A plane defined by the longitudinal axis 20 and the transverse axis 22 is preferably the same plane as the bottom surface 14 and the base 23.

The body 12 also includes a plurality of fingers, two of which are indicated by reference numeral 24. The plurality of fingers 24 is positioned along the longitudinal axis 20 of the body 12, and each finger 24 is positioned in generally the same orientation. If the object storage device is positioned on a base, the fingers 24 preferably protrude vertically from the surface of the base. Each finger 24 includes a upper portion 26, two finger end surfaces 28, and two finger side surfaces that partially define slits 30 with adjacent fingers 24.

The upper portions 26 are preferably an inverted v-shape as shown in the figures. As such, each upper portion 26 preferably defines an apex 32. The apex 32, as well as the other components of each finger 24, are preferably generally parallel to the transverse axis 22 of the body 12. Similarly, each finger 24 preferably has a generally constant cross-sectional shape as viewed in the direction of the transverse axis 22.

Alternatively, the upper portions 26 may simply include one or more planar diagonally extending surfaces instead of an inverted v-shape. For example, the upper portions 26 may include an upper surface (not shown) instead of an apex connecting the planar diagonally extending surfaces of the inverted v-shape. In any case, the upper portions 26 act as guide surfaces for objects stored using the device 10. Specifically, the upper portions 26 guide an object pressed against the upper portion 26 to the slits 30 for storage without the use of additional components, such as separate check plates including slots aligned with the slits 30 of the storage device. In addition, the planar diagonally extending surfaces of the upper portions 26 also permit objects to be inserted into the slits 30 more easily than other types of shapes, such as curved surfaces. Further still, the upper portions 26 permit easy identification of the location of the slits 30.

Each slit 30 is preferably a contact surface that provides contact with a stored object in two dimensions. The finger side surfaces that define each contact surface are preferably frictionally engaged, which should be understood as meaning the finger side surfaces are in contact or nearly in contact and separated by a uniform distance when an object is not held by the slit 30. Frictional engagement provides a strong hold for objects stored using the device 10.

The finger end surfaces 28 define the body end surfaces 16. The slits 30 preferably extend from one body end surface 16 to the opposite body end surface 16. The slits 30 also extend from feet 34 of the upper portions 26 to positions 36 spaced above the bottom surface 14. As such, the slits 30 preferably define a plane that is perpendicular to the plane defined by the longitudinal axis 20 and the transverse axis 22. In addition, the fingers 24 preferably have a shape such that the greatest width of each finger in the direction of the longitudinal axis 20 is the shortest distance between the slits 30 on opposite finger side surfaces. That is, the slits 30 are preferably parallel to one another.

The longitudinal ends of the body 12 preferably includes fingers 24. However, the longitudinal ends of the body 12 may optionally include two end fingers 38 having a different shape than the fingers 24. Each end finger 38 includes a upper portion 40 that may include a half inverted v-shaped portion 42. As shown in the figures, the half inverted v-shaped portion 42 faces an adjacent finger 24. The end fingers 38 are included with only the half inverted v-shaped portion 42 since end fingers 38 are only adjacent to one slit 30. That is, a full inverted v-shaped portion 42 on the end fingers 38 could direct objects away from the nearest slit 30.

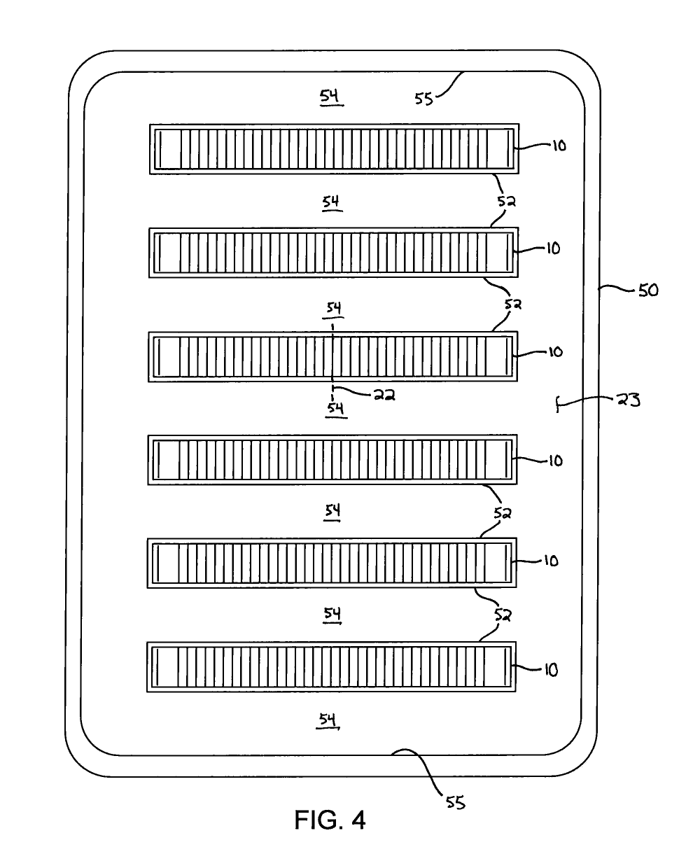

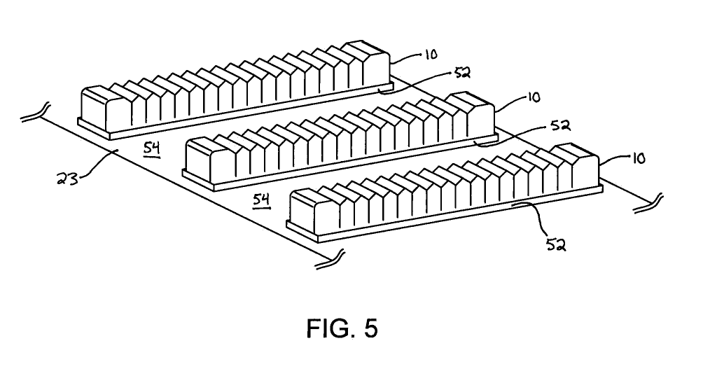

Referring now to FIGS. 4 and 5, the base 23 preferably supports several storage devices 10 (six storage devices 10 are shown in FIG. 4 as an example) and is disposed within a storage container 50. The base 23 includes a set of relatively short walls 52 (e.g., about one-fifth of the height of the storage devices 10) surrounding each device 10 so that the devices 10 may be properly located during manufacturing of the storage container 50. Furthermore, the base 23 also includes a planar surface 54 separating each pair of adjacent storage devices 10 and separating two of the devices 10 from longitudinal walls 55 of the storage container 50. Each of the planar surfaces 54 is preferably completely flat to provide a simplified design and space between adjacent devices 10 and the longitudinal walls 55. In addition, the planar surfaces 54 preferably have a width (in the direction of the transverse axis 22) between each pair of adjacent storage devices 10 and the longitudinal walls 55 of one to two times the thickness of a single storage device 10 in the direction of the transverse axis 22. Such a design advantageously provides a simple design in which contact between objects stored in adjacent devices 10 is reduced or eliminated. Furthermore, such a design also permits stored objects to extend from both body end surfaces 16 of the storage devices 10.

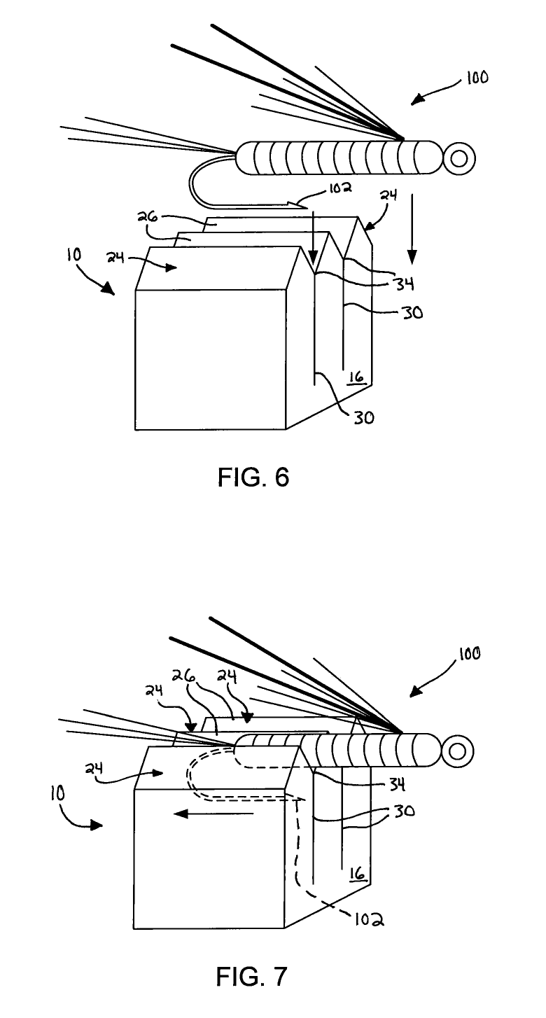

The object storage device 10 may be used as a storage device for fly fishing lures, although other uses are contemplated. For example, the object storage device 10 may be used to hold jewelry, sewing accessories, and other small objects. FIGS. 6 and 7 show an example of storing a fly fishing lure 100 using the object storage device 10. However, it should be understood that the object storage device 10 is only shown with three fingers 24 in FIGS. 6 and 7 for clarity. As shown in FIG. 6, the fly fishing lure 100 is inserted into a slit 30 of the device 10 by using the upper portion 26 as a guide for the lure 100 and pushing the lure 100 against a foot 34 of the slit 30. This is preferably done in a manner such that the hook 102 of the lure 100 does not pierce the device 10. As such, the lure 100 is held in place by friction forces due to contact between the sides of the hook 102 and the finger side surfaces of the slit 30. The fly fishing lure 100 may be removed from the slit 30 by pushing the lure 100 towards one of the body end surfaces 16 or the upper portion 26. The lure 100 is preferably removed by pushing it towards a body end surface 16 as shown in FIG. 7. The possibility of piercing the device 10 with the hook 102 is reduced by pushing the lure 100 in such a direction.

The object storage device 10 is preferably designed in such a manner so that objects stored in the device 10 do not fall out of the device 10 unintentionally. If the object storage device 10 is used for storing fishing lures and is attached to the base of a box, for example, the fishing lures preferably remain in place and held by the slits 30 if the box is dropped or turned upside down. This characteristic is advantageously provided because more surface area is committed to holding objects than in prior art designs.

The object storage device 10 is preferably sized such that the position of the fly 100 may be adjusted. As such, a ratio of the thickness dimension of the body 12 in the direction of the transverse axis 22 and the height dimension of the body 12 in the direction perpendicular to the plane defined by the longitudinal axis 20 and the transverse axis 22 is advantageously in the range of 7:8 to 9:8. Furthermore, the fingers 24 are preferably relatively narrow to permit the storage device 10 to support relatively small lures. As such, a ratio of the length of each finger 24 in the direction of the longitudinal axis 20 and the height dimension of the body 12 is preferably in the range of 3:7 to 5:7, and most preferably in the range of 3:7 to 4:7.

In addition to acting as a guide for an object, the upper portions 26 also permit easier identification of the slits 30 that designs in which objects are placed in the device from the side. This is provided due to the shape of the upper portions 26 and the positioning of the upper portions 26 away from the base of a storage box.

The object storage device 10 of the present invention is advantageously made from an elastomeric foam using a well known die-cutting operation. Specifically, the object storage device 10 is preferably made from ethylene vinyl acetate (EVA), although other materials may be used. In some applications, EVA is referred to as ‘foam rubber’. Those skilled in the art will recognize that EVA is appropriate for the present invention as it is flexible and soft. In addition, EVA can be processed in a similar manner to other thermoplastics. Those skilled in the art will also recognize that some deformation of the features of the device 10 may occur due to the characteristics of EVA. However, this deformation occurs without defeating the advantages of the present invention.

The present invention preferably provides a storage device in which the storage slits are easily identified, a device with sufficient size for adjustment of the position of a stored object, and a device which reduces the possibility of piercing the device with a stored object. Advantageously, this results in a storage device with simplified user interaction and a longer product life.

It is specifically intended that the present invention not be limited to the embodiments and illustrations contained herein, but include modified forms of those embodiments including portions of the embodiments and combinations of elements of different embodiments as come within the scope of the following claims.

I claim:

1. An object storage device, comprising:
a base;
a deformable body having a bottom surface fixed to the base, body end surfaces defining a transverse axis extending between the body end surfaces, a longitudinal axis being perpendicular to the transverse axis, and a plurality of fingers, each finger including:
an upper portion opposite the bottom surface, the upper portion including at least one planar diagonally extending surface being configured to guide an object;
finger side surfaces, the finger side surfaces of adjacent fingers being frictionally engaged.

2. The object storage device of claim 1, wherein the upper portion of each finger has an inverted v-shape.

3. The object storage device of claim 1, wherein each finger side surface extends between a foot of the upper portion and ends at a position spaced apart from the bottom surface.

4. The object storage device of claim 1, wherein each upper portion includes an apex that is substantially parallel to the transverse axis.

5. The object storage device of claim 1, wherein each finger has a generally constant cross-sectional shape as viewed in the direction of the transverse axis.

6. The object storage device of claim 1, wherein the finger side surfaces extend from a first of the body end surfaces to a second of the body end surfaces.

7. The object storage device of claim 1, wherein each finger side surface is generally perpendicular to a plane defined by the longitudinal axis and the transverse axis.

8. The object storage device of claim 1, wherein the plurality of fingers is positioned along the longitudinal axis.

9. The object storage device of claim 1, wherein the plurality of fingers is positioned in substantially the same orientation.

10. The object storage device of claim 1, wherein the finger side surfaces are generally parallel to one another.

11. The object storage device of claim 1, wherein the body is made of ethylene vinyl acetate.

12. The object storage device of claim 1, wherein a thickness dimension of the body in the direction of the transverse axis and a height dimension of the body in a direction perpendicular to a plane defined by the longitudinal axis and the transverse axis have a ratio in the range of 7:8 to 9:8.

13. An object storage device, comprising:
a container including a base connected to a plurality of walls;
a plurality of deformable bodies, each deformable body having a bottom surface fixed to the base, body end surfaces, a longitudinal axis, a transverse axis extending between the body end surfaces, the transverse axis defining a thickness dimension of each deformable body, each deformable body being spaced apart from adjacent deformable bodies and at least some of the walls by at least the thickness dimension, and each deformable body including a plurality of fingers, each finger including:
an upper portion opposite the bottom surface being configured to guide an object; and
finger side surfaces, the finger side surfaces of adjacent fingers being configured to support an object.

14. The object storage device of claim 13, wherein the at least some of the walls includes longitudinal walls of the container extending in a direction of the longitudinal axes of the deformable bodies.

15. The object storage device of claim 13, wherein the plurality of fingers is positioned along a longitudinal axis.

16. The object storage device of claim 13, wherein each finger has a substantially constant cross-sectional shape as viewed in the direction of a transverse axis.

17. The object storage device of claim 13, wherein each of the finger side surfaces defines a plane that is generally perpendicular to a plane defined by at least one of the body side surfaces.

18. The object storage device of claim 13, wherein the finger side surfaces are generally parallel to one another.

19. The object storage device of claim 13, wherein the body is made of ethylene vinyl acetate.

20. The object storage device of claim 13, wherein a thickness dimension of the body in the direction of a transverse axis and a height dimension of the body in a direction perpendicular to a plane defined by a longitudinal axis and the transverse axis have a ratio in the range of 7:8 to 9:8.
